(19) United States
(12) Patent Application Publication
(10) Pub. No.: US 2007/0227747 A1
(43) Pub. Date: Oct. 4, 2007

(54) Fire Extinguishing Unit

(76) Inventor: Igor A. Lepeshinsky, Moscow (RU)

Correspondence Address: MCDERMOTT WILL & EMERY LLP, 600 13TH STREET, N.W., WASHINGTON, DC, 20005-3096, US

(21) Appl. No.: 10/587,400

(22) PCT Filed: Mar. 22, 2004
(86) PCT No.: PCT/RU04/00110

§ 371 Date: May 25, 2007

(30) Foreign Application Priority Data
Jan. 27, 2004 (RU) 2004101951

(51) Int. Cl. A62C 13/64

(52) U.S. Cl. 169/9

(57) ABSTRACT

The invention proposed is related to designs of units for extinguishing fire and is destined for suppression local fires of solid flammable substances, flammable liquids, electrical equipment under voltage, in homes, offices and outside. The technical result in the invention proposed is achieved by creation of a fire extinguishing unit with foam generating device.

The invention is also characterized by the following: the jet forming barrel is designed as a composite and its end (13) is installed with a possibility of the barrel axis turn and its removal from the jet. Composite jet forming barrel design used in the proposed invention provides more effective operation: at the same dispersion of water drops the range of jet is increased in 1.5 times (15 m instead of 10 m) for compact jet mode, in 2.5 times (10 m instead of 4 m) for spray mode, and also in 3 times the time of switching between modes is shortened and the jet velocity increased.

### AREA OF TECHNICS

The invention proposed is related to designs of units for extinguishing fire and is destined for suppression local fires of solid flammable substances, flammable liquids, electrical equipment under voltage, in homes, offices and outside.

Previous Level of Technics.

The most close in technical essence to the proposed unit is the back pack firefighting unit that includes the basis frame, fixed on it capacity for fire extinguishing agent and attached to it through the control block capacity for air, connected with these capacities through the corresponding mains device for generation of two-phase extinguishing jet that includes jet forming barrel and lever mechanism for unit starting with extinguishing agent and air supply valves, mounted in mains, mechanism of changing mode of the jet and the system of extinguishing liquid filling (see I. A. Lepeshinskiy “Unique firefighting system” Aerodynamic courier #3, 1999).

In the known design the mechanism of changing modes of the jet is implemented in the form of different nozzles replaced when in use, which makes the unit design and operation more complicated.

In the known design the system of extinguishing liquid filling is implemented in the form of screw-top on the extinguishing liquid capacity filling throat.

Disadvantages of the known design are the following:

lack of autonomous foam generating system in the known unit. Since the foamer must be added to the extinguishing agent capacity prior to work, extinguishing liquid can de used either with foamer, either without foamer. This is inconvenient because when suppressing fire on installations under voltage, the use of foamer is inadmissible.

Hence, if the unit on duty is filled with foamer solution, it is necessary to refill it before suppressing fire on an electrical installation.

one, but big non-standard cylinder leads to the increase of unit overall dimensions and lowering its centering;

the design of jet forming barrel does not allow receiving improved parameters of fire suppressing liquid jet, which provide more effective work of the unit, but requires both hands for operating the unit;

significant time of filling with water and foamer because both extinguishing agent and the foamer are filled through upper cover fastened on thread and requires time for screwing off.

Besides that when filling the known unit with foamer through the filling throat, intensive foaming of the solution occurs and increases time of filling significantly.

### PROPOSED INVENTION DISCLOSURE

The problem solved by the proposed invention is creation of firefighting unit with design that excludes the abovementioned disadvantages.

The technical result in the proposed invention is achieved by creation the firefighting unit consisting of basis frame, fixed on it capacity for fire extinguishing agent and attached to it through the control block capacity for air, connected with these capacities through the corresponding mains device for generation of two-phase extinguishing jet that includes jet forming barrel and lever mechanism for unit starting with extinguishing agent and air supply valves, mounted in mains and the system of extinguishing liquid filling which, according to the invention, is supplied with the device for forming foam.

The invention is also characterized by the following: the jet forming barrel is designed as a composite and its end is installed with a possibility of the barrel axis turn and its removal from the jet.

Composite jet forming barrel design used in the proposed invention provides more effective operation: at the same dispersion of water drops the range of jet is increased in 1.5 times (15 m instead of 10 m) for compact jet mode, in 2.5 times (10 m instead of 4 m) for spray mode, and also in 3 times the time of switching between modes is shortened and the jet velocity increased.

Using at least two standard cylinders connected with the mains as a capacity for extinguishing agent allowed to decrease longitudinal and transversal sizes of the unit, improve its centering due to approaching the center of mass to the frame, decrease overall weight of capacity for extinguishing agent and its cost.

The invention is also characterized by the following: the foam generating device is connected with extinguishing agent and air supply mains through devices of switching on and off, for example, valves. It allows autonomously and right at the moment of need to change the unit working mode to using foamer because foamer is mixed with extinguishing liquid not in the cylinder but in the mains.

Placing the liquid and air supply valves control lever in parallel with the two-phase jet forming barrel decreases the barrel weight and allows to control the barrel by one hand.

Making the filling system as a quick-disconnecting joint in the extinguishing liquid mains allowed to decrease the time of filling and to fill the extinguishing liquid and the foamer simultaneously.

Making the basis as a frame with straps fixed on it allows using this unit as a back pack.

In case of using vehicle (motorcycle, hand cart, etc.) as a basis bigger number of cylinder can be transported to the place of fire.

The design proposed provides less damage for units when inaccurately used due to less probability of cylinders damage and also using a more reliable frame design.

The design proposed is universal because in the most is can be assembled from standard parts.

Carried out patent search showed that technical solutions with specified aggregate of significant characteristics in similar designs of firefighting units are not known, so the proposed technical solution meets the “novelty” requirement.

The analysis of known analogs and a prototype did not discover a proposal with aggregate of significant characteristics stated in the formula of invention, so for specialists in the area of firefighting these characteristics are not evident, and, appropriately, meet the “inventive height” requirement.

We deem that information disclosed in the application materials is sufficient for practical reduction of the invention.

### DRAWINGS DISCLOSURE

The invention proposed is illustrated by the following description of the device and drawings, where

FIG. 1 presents the firefighting unit scheme;

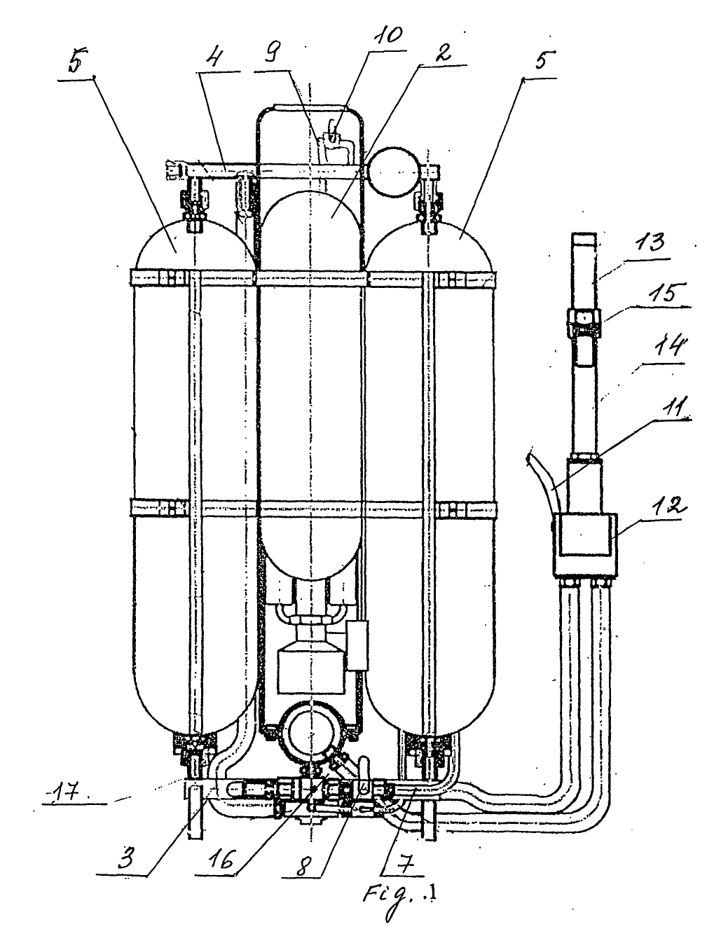

FIG. 2-A-A crosscut of the unit.

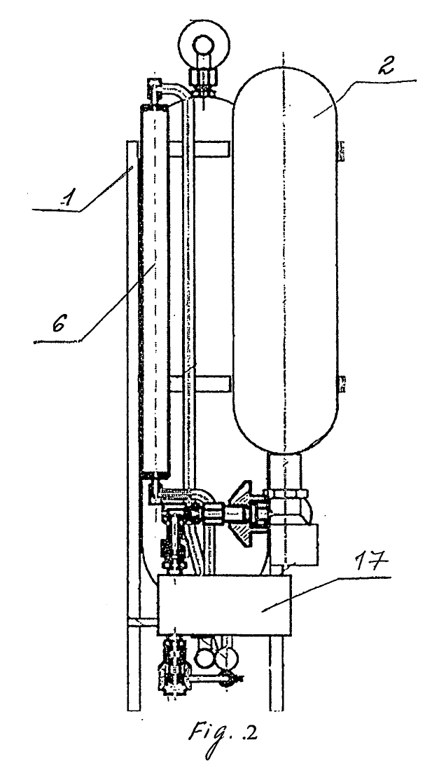

The best variant of the proposed design realization

The proposed firefighting unit includes the basis 1, fixed on it capacity for fire extinguishing liquid and capacity for air 2 connected with it through control block 17, for example a cylinder, connected with it through mains 3 and 4 respectively, the device for generating foam, the device for forming two-phase extinguishing jet and the system of extinguishing liquid filling.

Here the capacity for extinguishing liquid is made as at least two cylinders 5 connected with each other by the mains 3.

The block 17 serves for reducing pressure of air entering capacities with liquid and the barrel to necessary level.

The device for generating foam is made in the form, for example of a cylinder 6, which is connected with the extinguishing liquid supply mains 3 through the mains 7, switching on/off device, for example valve 8 and connecting mains 9 and switching on/off device, for example valve 10 with air supply mains 4.

In the invention proposed the device for generating a two-phase extinguishing jet consists of the jet forming barrel, parallel to it control lever 11 with valves on liquid and air supplies (not shown on the drawing), installed in the body 12 of the barrel.

The jet forming barrel is composite, moreover its end 13 is installed with the possibility of a turn around the axis of its other part 14, and is assigned for accelerating the gas-drops flow of a dispersion structure or for generating a gas-drops jet.

The unit 15 serves for disconnecting two parts 13 and 14 of the barrel and removing the end 13 of the nozzle from the flow of liquid due to its deflection from the flow axis.

The filling system is made in the form of a quick-disconnecting joint 16 installed in the extinguishing liquid supply mains 3.

Depending on the area of application of the proposed unit, its basis 1 can be made as a frame with straps (not shown on the drawing), or as carrier, for example hand cart, etc.

As the operation of the proposed unit is the same for all types of basis designs, let's examine its work in case when the basis 1 is a frame with straps—a back pack unit design.

First of all the init filling with extinguishing liquid and foamer is performed. To perform this, liquid supply mains 3 from cylinder 5 and connecting mains 7, serving for foamer supply to mains 3, is disconnected in quick-disconnecting joint 16.

The side of quick-disconnecting joint 16 connected to mains 3, through the quick-disconnecting joint connecting element (not shown on the drawing), is connected to the filling pipe. The air pressure relief in the system occurs through the relief valve (not shown on the drawing) and air supply mains 4.

The other side of quick-disconnecting joint 16 through its connecting element (not shown on the drawing) is switched to the roamer filling pipe.

Here both valves 8 and 10 are open. Air supply mains 4 must also be open to atmosphere as when filling with liquid.

After filling with liquid and foamer valves 8 and 10 must be closed, mains 3—disconnected from filling pipes and quick-disconnecting joint 16 connected. The valve from air supply mains 4 to atmosphere is closed and the air cylinder 2 is attached. Then the air cylinder 2 stopcock is opened.

The unit is completely ready for operation now.

The operator directs the jet forming barrel on the object on fire and pushes the extinguishing liquid and air control lever. Liquid and air enter the jet forming device where the compact two phase jet is generated.

Two phase jet is generated by liquid dispersing, mixing it with air and due to this gas-drops structure flow is generated and delivered to the barrel where it is accelerated to the jet speed on the outlet of the nozzle part 14 equal to or higher then the speed of sound in two phase flow.

Further acceleration of the jet occurs in the nozzle end 13, at that the jet on the outlet has small spray angle.

For spray angle increase, the operator disconnects the nozzle end 13 from part 14 with the unit 15 and removes it from the flow turning it around the unit 14 axis.

When using jet forming barrel of this design it is possible to achieve 15 degrees spray angle.

The pilot unit was manufactured and tested at the following parameters:
Pₖ=5×10⁵ Pa—pressure in mixing chamber;
G₁=0.350 kg/sec—mass flow rate of liquid;
G_{g}=0.007 kg/sec—mass flow rate of gas;
P₁=10×10⁵ Pa—pressure of liquid;
P_{N}=10⁵ Pa—atmospheric pressure.

For comparison the prototype data received in similar conditions is shown in Table 1.

It is necessary to outline that liquid and gas flow rates of the prototype are higher (G₁=0.4 kg/sec, G_{g}=0.01 kg/sec).

Having all the rest conditions identical, water and air flow rate increase increases the jet range. Nevertheless, the proposed invention shows better results then the prototype.

TABLE 1

| Parameter Name | Prototype | Proposed design |
|---|---|---|
| Extinguishing liquid | water (water with foamer) | water (water with |
| | | foamer) |
| Volume of extinguishing | 10 liters | 10 liters |
| liquid | | |
| Dispersity of water drops | ˜100 microns | ˜100 microns |
| Mass when filled | less then 20 kg | less then 20 kg |
| Velocity of jet in the area | not less then 20 m/sec | not less then |
| of fife seat | | 20 m/sec |
| Dimensions | 600 × 450 × 300 mm | 693 × 354 × |
| | | 210 mm |
| Refilling time | 40-60 sec | 20-30 sec |
| Acceptable voltage when | up to 36000 V | up to 36000 V |
| extinguishing fire on | | |
| electrical installation | | |
| under load from the | | |
| distance not less 1 m | | |
| Jet range | up to 10 m | up to 15 m |
| Sprayed jet range | up to 4 m | up to 10 m |

1. Fire extinguishing unit, including basis (1), fixed on it capacity for extinguishing liquid (5) and connected to the capacity through control block (17) capacity for air (2), connected to them through corresponding mains (3 and 4) device for forming two phase extinguishing jet, consisting of the jet forming barrel and placed in mains liquid and air supply valves control lever (11) and the system of filling extinguishing liquid, differing because it is supplied with device for generating foam.

2. Fire extinguishing unit according to Clause 1, differing because the extinguishing liquid capacity is made of at least two cylinders (5) connected with each other by mains (3).

3. Fire extinguishing unit according to any of Clauses 1, 2, differing because foam generating device (6) is connected to extinguishing liquid and air supply mains through switching on/off devices, for example valves (8).

4. Fire extinguishing unit according to any of Clauses 1-3, differing because the jet forming barrel is made composite, moreover its end (13) is installed with possibility of turn from the barrel axis and its removal from extinguishing jet.

5. Fire extinguishing unit according to any of Clauses 1-4, differing because liquid and air supply control lever (11) is parallel to the two phase extinguishing jet forming barrel.

6. Fire extinguishing unit according to any of Clauses 1-5, differing because the system of extinguishing liquid filling is made as quick-disconnecting joint (16) installed in extinguishing liquid supply mains (3).

7. Fire extinguishing unit according to any of Clauses 1-6, differing because the unit base (1) is made as a frame with straps fixed on it.

8. Fire extinguishing unit according to any of Clauses 1-6 differing because the unit base (1) is made as a vehicle.
